(19) United States
(12) Patent Application Publication
(10) Pub. No.: US 2014/0097585 A1
(43) Pub. Date: Apr. 10, 2014

(54) DK3D Dolly

(71) Applicant: Michael Dallas Baird, Maryville, TN (US)

(72) Inventor: Michael Dallas Baird, Maryville, TN (US)

(21) Appl. No.: 13/645,702

(22) Filed: Oct. 5, 2012

(51) Int. Cl. B62B 3/04

(52) U.S. Cl. 280/63

(57) ABSTRACT

A load bearing dolly securely attached, via lashing straps, to opposite ends of any moveable object such as: household furniture items, appliances, or various manufacturing/industrial equipment. Each rectangular dolly frame being carpeted on all contact surfaces creating friction and containing two 360 degree swivel casters of various sizes and optional locking brakes. Designed to accommodate even items of irregular shape and fixedly secured to dollies to maneuver over various terrains. Specifically, having a platform that will be parallel to the ground or continue to rise until it makes contact with moveable object at any varying degree of angle, then securing through points of contact on the platform frame, as well as, secured from above via the strapping.

### FIELD OF THE INVENTION

This invention pertains to dollies specifically used to move, relocate, and transport various items such as household furniture, appliances, and heavy equipment.

### BACKGROUND OF THE INVENTION

Dollies of various structures have been used in multiple applications to move large pieces of furniture, household appliances, industrial equipment, and other objects which are difficult to maneuver by a single person without assistance. Cross referencing such examples are U.S. Pat. Nos. 2,953,387, 3,105,698, 3,272,529, 4,029,327, 4,852,895, and 6,386,560 B2. Typically, these devices are comprised of a metal frame fixedly attached to wheels for transport and are designed to move or transport specific items or objects. Acknowledging the fundamental and structural differences between aforementioned documents, below are distinctions from the present invention.

U.S. Pat. No. 6,386,560 B2 issued on May 14, 2002 to Joseph P. Calender, titled “Dolly for Large Appliances”, describes a device used to move specifically large vending machines and refrigerators. The structural design is that of a solid, metal platform to which the item is carried upon and four fixed casters, two being on each end of the platform apparatus. Interconnected to the platform is a foot plate to provide leverage in raising device and object over irregular surfaces. Opposite the manual operator is an attached bar through which a strapping mechanism can be adhered around the body of the object for some stability in transport. No means are provided for residential household uses. Accordingly, further differences include the strapping not coming over the top of the object to fixedly adhere object to moving platform surface.

U.S. Pat. No. 4,852,895 issued on Aug. 1, 1989 to Don Moffitt, titled “Dolly” describes a device attached to one end of an object allowing an individual to stand on the opposite end of the object and thereby lifting that end move object to a different location within short distances. The structural design is that of a metal bar with adjustable width having two, one-directional casters attached. Then a handle bar raises up from the rear of the object to press flush with outer most side and is fixed into place using an elastic cord to hook into handle bar. Most important difference being the wheels will not allow multi-directional movement of object, therefore, causing manual mover additional work to maneuver object around corners or into different rooms. Furthermore, extremely heavy objects would be impossible to move having dolly affixed to one side and carrying the bourdon of the object's weight in the hands of the mover.

U.S. Pat. No. 4,123,819 issued on Nov. 7, 1978 to Stefano Benedetti, titled “Bi-directional Re-entering Wheel for Fixed and Extendible Trolleys and Feet” describes a device which is snapped together according to object size and allows for manual transport of heavy objects to alternate locations. Not found in this invention is any way of securing object to transport mechanism. In addition, the weight of the object will inadvertently be dispersed to the side of the object not supported by this mechanism and therefore into the hands of the individual attempting to relocate such object. Also irregular shaped items cannot be transported due to not having a support platform, only a bar beneath the item.

U.S. Pat. No. 4,029,327 issued on Jun. 14, 1977 to Samuel Kolstein, titled “Stroller for Attachment to a Carrying Case” describes a device with a rounded base platform to cradle objects which are round or curved in nature. Beneath the platform are two casters which provide 360 degree movement, as well, as a strapping belt to secure objects to the platform. However this device can be utilized only when the desired object is shaped accordingly to the strollers' curved platform design, specifically barrels, trash cans, guitar cases or similar items.

U.S. Pat. No. 3,272,529 issued on Sep. 13, 1966 to Isadore B. Rachman, titled “Safety Clamp Handle Convertible to a Wheel Assembly” describes a two part device, the upper part clamping to object and providing a handle bar or steering handle while the lower portion of the device adheres to the object in a similar manner allowing the mover to tilt the object back and transport on the supporting two caster frame. However, the frame base design is that to support the transport of highly specified objects, namely elongated gas holding tanks and cylindrical drums. Objects not possessing this curved or rounded shaped would be impossible to transport using this mechanism.

U.S. Pat. No. 3,105,698 issued on Oct. 1, 1963 to Paul J. Bonarrigo, Dunmore, and Martin J. Ginsburg, titled “Dolly for Enabling a Single Operator to Move a Work Table” describes a device having a base platform created at a right angle thus providing a lip to prevent objects from sliding off the back of the device and one caster mounted to each end of the platform for portability. This device is designed specifically for moving tables, therefore, there is no way to move other types of objects, in addition, the casters move only forward or reverse causing the mover to allocate more space to make turns, as well as, the mover must handle the opposite end of the table to transport object to new location without the ability to secure object to transport device.

U.S. Pat. No. 2,953,387 issued on Sep. 20, 1960 to Albert S. Portner, titled “Supporting Device” describes a device that is fixedly attached to an item; specifically a cylindrical trash can, via screws or bolts. The mechanism does have single direction casters for the mobility of the trash cans. This device does not allow for multiple uses other than that described above. Therefore, no household items or appliances could be transported through the use of this device.

U.S. Pat. No. 2,919,138 issued on Dec. 29, 1959 to Bailey Brower, Patchogue, and John F. Phillips, titled “Dolly Attachments for Suit Cases and Like Articles of Manufacture” describes a device to assist in the transport of a suitcase with a spring loaded frame to adjust for width, side plates to secure object on frame, and single direction casters to ease in transport. The device does not have a platform in which an item can rest, resulting in limited applicable uses of such device. As well, there is no means of securing items to the device frame from above or around the object.

### SUMMARY OF THE INVENTION

The DK3D Dolly overcomes many obstacles one may encounter while transporting various items: dressers, sofas, entertainment centers, appliances, as well as, heavy duty manufacturing or industrial equipment. The frame of the device is rectangular in shape comprising the dolly platform. At the rear of the platform is a raised lip to prevent objects from sliding off the rear end of the dolly. Beneath the lip two multi-directional casters are mounted allowing for 360 degree movement. The casters are available in 2″, 3″, and 4″ wheel sizes and with or without a total lock, braking system. The entire surface of the platform and lip is covered in heavy duty carpeting to create additional friction between the dolly and the object. Two milled slots are present in the frame to which a lashing strap is fed. The lashing strap adheres via a cam buckle or ratchet strapping mechanism. This is a key aspect to the invention in two parts: it secures any and every item to the dolly for transport and it raises the front of the dolly to meet any solid surface under the object. If the object is flat on the bottom, such as a washing machine, the dolly platform will rise until it meets the bottom of the washing machine and will be parallel to the floor. If the object is contoured on the bottom, such as a dresser or entertainment center, the platform will continue to rise until it creates four points of contact, two on the rear lip and two underneath the object even past a 45 degree angle.

### BRIEF DESCRIPTION OF THE DRAWINGS

FIG. 1 depicts the dolly attached to an irregular bottom surface object with the platform raised at an angle and secured to the object for transport.

FIG. 2 is an alternate depiction of the dolly secured to any object with a flat surface on the bottom.

FIG. 3 is a bottom view of the dolly showing the frame construction and positioning of casters.

FIG. 4 is a side view of the dolly also showing the position of the casters in relation to the raised lip.

FIG. 5 is a rear view of the dolly.

FIG. 6 is a top view of the dolly, also illustrating the transparent frame through this view.

### DETAILED DESCRIPTION

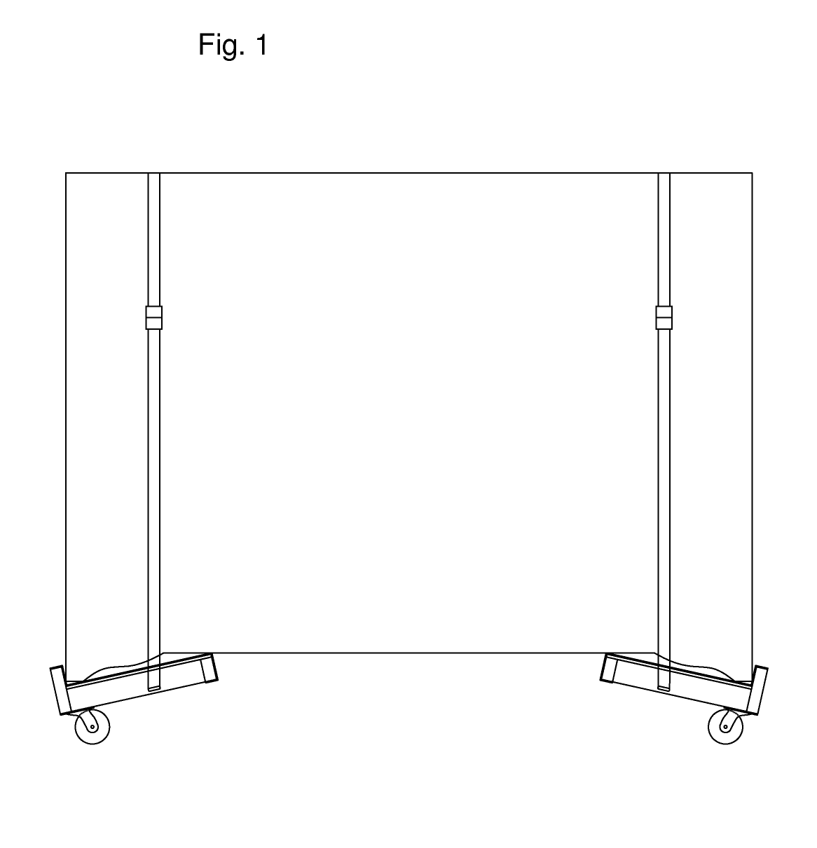

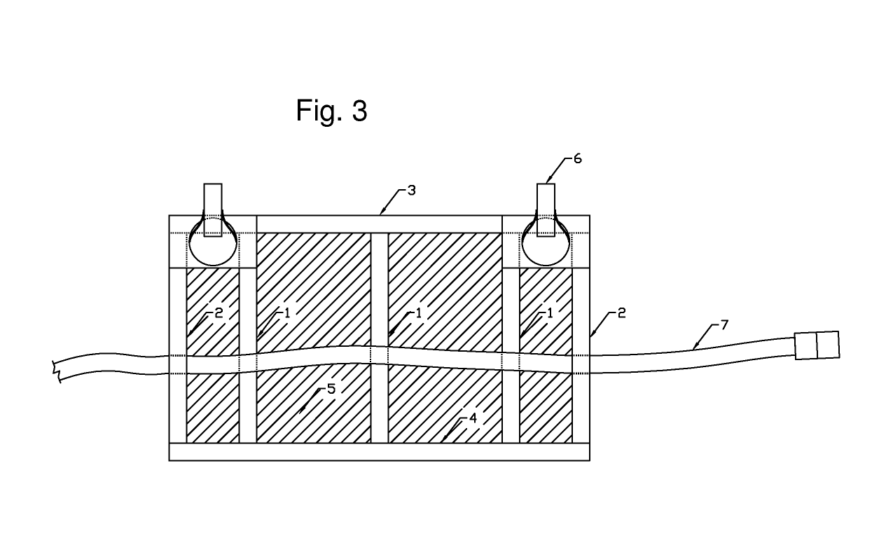

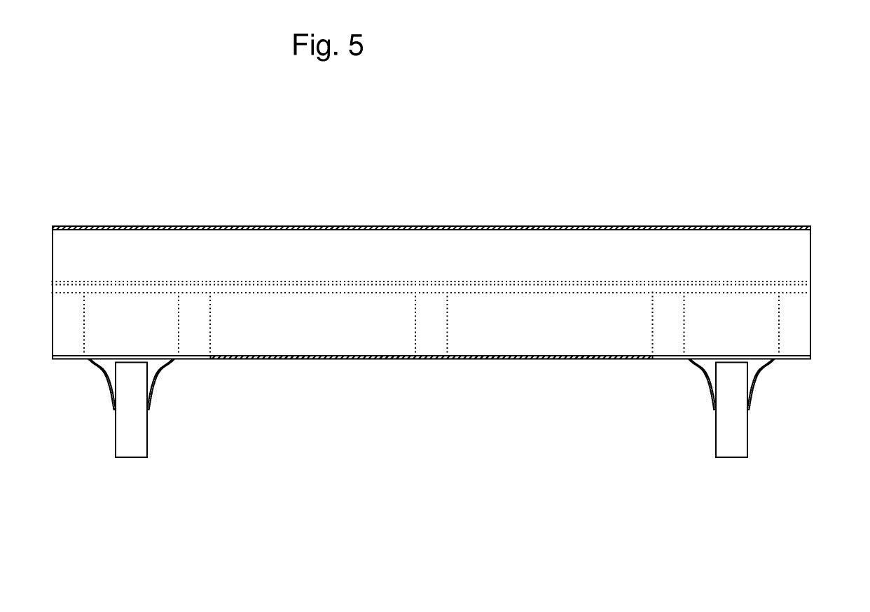

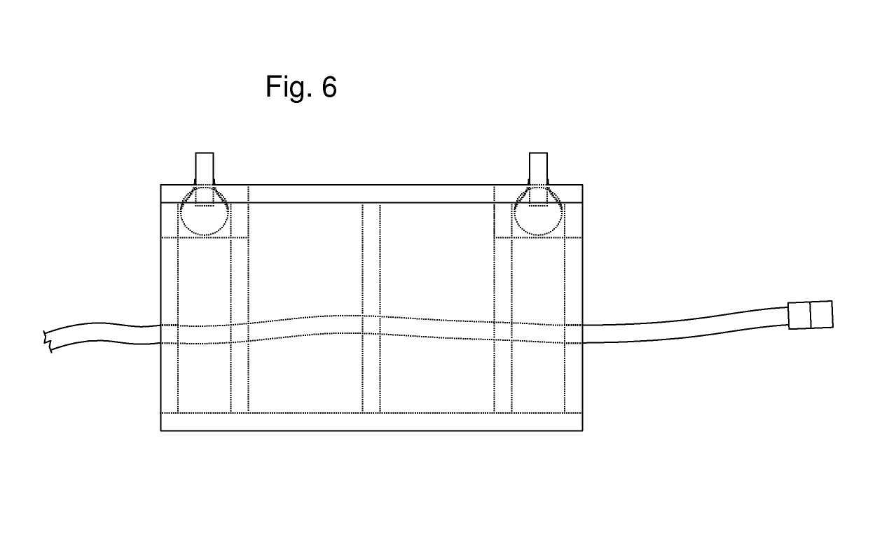

In reference to the attached drawings FIGS. 1-6 the dolly is constructed of a rectangular frame. In reference specifically to FIG. 3 the upper most piece of the structure 3 is a single piece of 1″×4″×24″ planking. Attached beneath are three additional planks 1 of 1″×2″×12″ pieces evenly spaces in the center of the frame. On the outer most edges are two planks 2 1″×2″×12″ with these specific planks each having a 1″ milled slot 9 that the lashing strap 7 is fed through, lashing strap contains either cam buckle or ratchet tie down mechanism. All perpendicular beams are connected to the lower plank 4 which is a 1″×2″×24″ piece. The upper left and right corners of FIG. 3 house the swivel casters 6 in a 2″, 3″, or 4″ wheel and locking brake optional. Once the frame is assembled the platform 5 is mounted which is comprised of one ¼″×13″×24″ piece of ply board or OSB board.

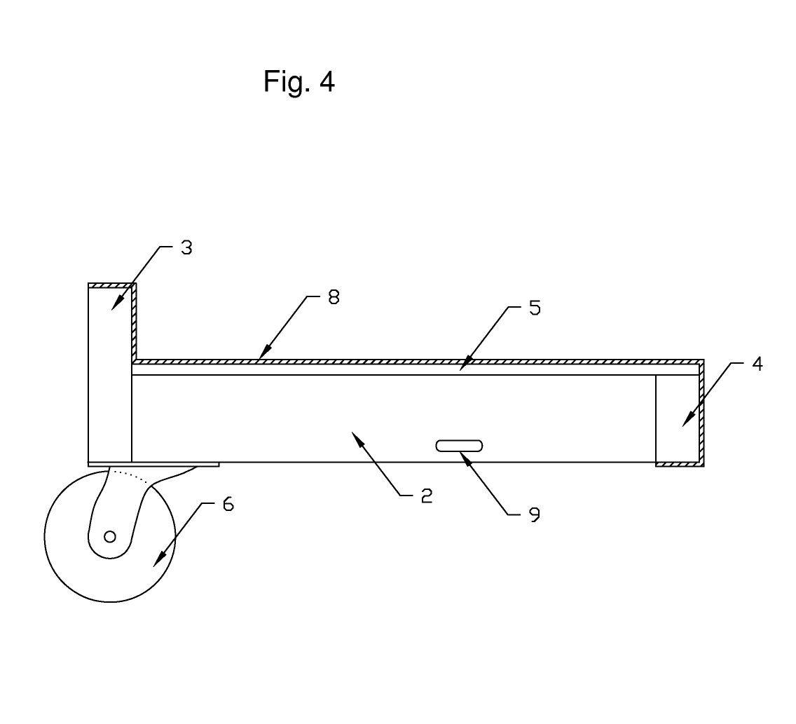

FIG. 4 shows the side view of the dolly and illustrates the corresponding relationship of each piece with the addition of the carpeting 8 contact surface. The position of the milled slot 9 also may be located in the center of the end planks 2 or positioned at any point closer to the front, non-caster end of the dolly frame. All plank pieces 1-4 may interchangeably be comprised of a hardwood, plastic, or metal material depending on application and need of each consumer.

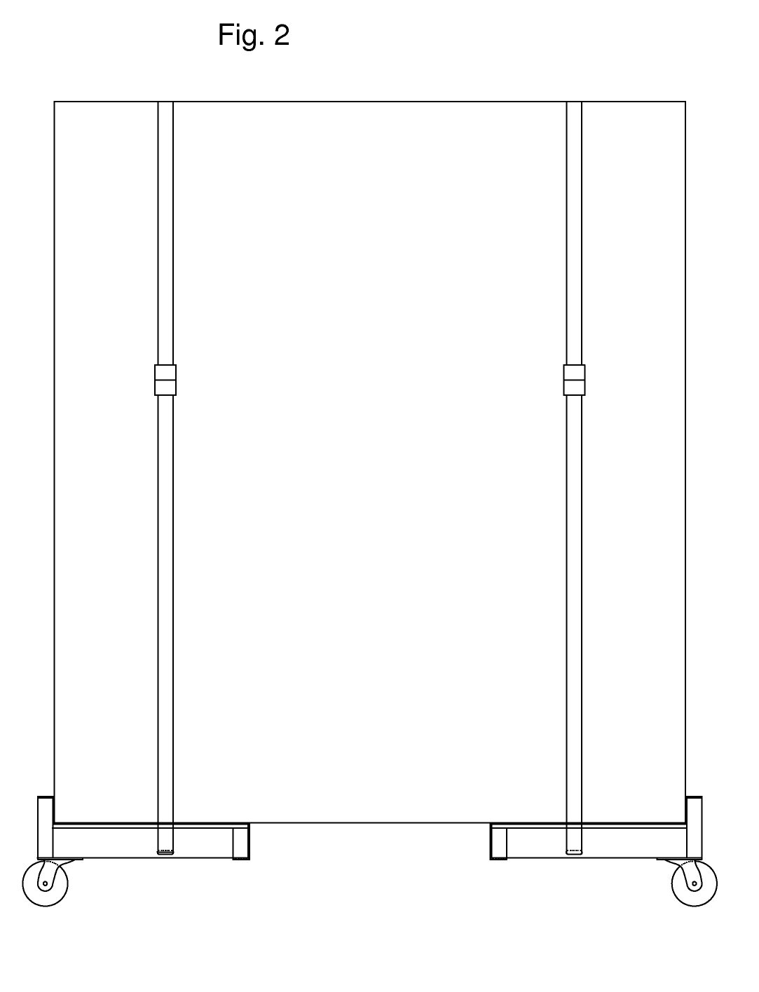

FIG. 1 displays a pair of dollies attached to an object with an irregular bottom surface and shows the unique characteristic of this dolly rising to make contact underneath said irregular surface. The object is fixedly attached to each dolly platform via the cam buckle lashing straps. Additionally, FIG. 2 displays the dolly mechanism loaded and secured to an object with a flat bottom surface therefore making the dolly platform parallel to the ground instead of at an angle of varying degree.

I claim:

1. A dolly, rectangular in shape, containing a supported platform and rear catching lip which is carpeted for contact with all surfaces, and each containing two 360 degree swivel casters of various sizes and locking brakes optional, also having milled slots through which a lashing strap is fed and attached via cam buckle or ratchet strap, to secure any moveable object of any size and any constructed material, whether household, commercial, or industrial in nature, without the assistance of any additional personnel, by simply lifting one end of the object either manually by hand, with jack or crane assistance etc., positioning dolly beneath, and securing strapping to adhere object to dolly platform, then repeating the process on the other end of the object, thus allowing the mover to singlehandedly maneuver the object over any varying terrain, such as from carpet, hardwood, grass, gravel, to a trailer and such, to relocate said object while the dolly and object remain connected, as well as, being able to keep objects loaded on dollies and with locked brakes on each caster transport in a vehicle or trailer, and simply unlock casters at destination for removal, inversely to unload objects from dollies, one would undo strapping, thus allowing platform front to drop to the ground, thereby lifting that end and sliding dolly out of position and repeating same process on the other attached end.
